(19) United States
(12) Patent Application Publication
(10) Pub. No.: US 2017/0129270 A1
(43) Pub. Date: May 11, 2017

(54) MODULAR TEXTBOOK DESIGN WITH MAGNETIC SPINE

(71) Applicant: Conrad Nelson, Stow, MA (US)

(72) Inventor: Conrad Nelson, Stow, MA (US)

(21) Appl. No.: 14/268,013

(22) Filed: May 2, 2014

(51) Int. Cl. B42D 1/06; B42D 1/00

(52) U.S. Cl. CPC B42D 1/06; B42D 1/001

(57) ABSTRACT

Two book covers are connected to a single spine that is both magnetic and expandable in order to encase a plurality of sections, each of which is composed of a plurality of pages that are grouped by a single magnetic binding strip. The magnetic strip allows for the section to be removed from its original book and collected into a unique organization of several sections, all of which may come from different books and may be securely kept inside a single pair of book covers that has a magnetic spine.

The present invention is directed towards books, and more specifically, towards books that may separate into multiple sections of pages—a division that may be based on chapters or particular subject matter.

### REFERENCE TO RELATED APPLICATION

The invention under US patent number US 2003/0210948 A1 is a notebook with a supplemental bound component, which includes a plurality of pages and a single cover or multiple covers. The binding mechanism in said invention involves a wire binding mechanism, whereas the binding mechanism in the present invention involves magnetic attraction between two or more magnets. The covers in said invention are of sheet-like material, whereas the covers in the present invention are a firm continuous surface. The covers in said invention are also generally rectangular, whereas the covers in the present invention may vary in dimension and shape and may not have sharp corners to be classified as rectangular.

The invention under U.S. Pat. No. 7,823,926 B2 is a dual notebook that is two notebooks bound to each other such that they may be used in conjunction to each other. Said invention involves multiple covers, a plurality of pages, and twin-wire coils. The binding of said invention is contrary to the present invention in that the binding of the present invention is dependent on the magnetic attraction between multiple magnets.

The invention under U.S. Pat. No. 4,527,814 A is a device that covers books in a protective manner. Said invention differs from the present invention almost by entirety, though some features may be recognized as similar. The said invention has a spine that accommodates the size of the spine of the book for which it covers, whereas the present invention has an expandable spine that expands or compresses as according to the thickness of the contents it contains. Also similar, both the said invention and the present invention are applicable to books.

The invention under US patent number US 2013/0223917 A1 is a device very similar to the Ring Binder (U.S. Pat. No. 5,607,246 A); the primary difference is that the front and back covers may be attached to and detached from the spine. Said invention has some features similar to the present invention, one of these features being the ability for the cover to detach from the contents of the book. The spine of said invention is described as having ridged front and back edges, whereas the spine of the present invention is expandable and therefore does not have such defined edges. Said invention includes pockets on the insides of the covers, whereas the present invention may include pouches for paper or other materials; the pouches in the present invention may or may not be detachable from the covers and therefore are unique to the pockets described in US 2013/0223917 A1.

The invention under US patent number US 2001/0089675 A1 is the Composition Book and may be related to the present invention be it there is a front and back cover and multiple sections of a plurality of pages in both inventions. The manifestations of these features differ between the inventions, however. The front and back covers of said invention are of smaller dimensions and are stitched to the pages, whereas the covers of the present invention are of larger dimensions and are not stitched to the pages or contents of the book. Also, the sections of pages in the present invention are grouped by magnetic material. This is not the case for the sections of pages in the invention under US patent number US 2001/0089675 A1.

The invention under U.S. Pat. No. 7,232,157 B2 shows a modular book enclosed in an artistic case. Said invention comprises a blank book whereas the present invention comprises pages filled out with written or typed text. Said invention is a memorandum designated as a successive timeline for a family, whereas the present invention has no such application as it is intended primarily for educational purposes. Said invention is described as having holders whereas the present invention may or may not have pouches inside the covers. Along with the aforementioned aspects, these two inventions may be seen as two different inventions.

The invention under U.S. Pat. No. 5,836,614 A is a book with various sections comprising a plurality of stacked sheets. These sections of said invention are illustrated as being divided about the vertical edges of the book, whereas the present invention includes groups of a plurality of pages that are not divided about the vertical edges of the book. The pages included in the groups of a plurality of pages in the present invention are of full size. Illustrations of said invention represent pages that are a half or a third of the size of standard 8½×11 inch paper. Also, said invention incorporates a spiral binding that involves wire whereas the present invention utilizes a binding that is completely dependent on magnets.

The invention under European patent number EP 2261051 A1 is a book system that binds inner pages to a spine that has several through holes, a spiral binding element, and a locking rod, whereas the present invention involves a binding system fully dependent on magnetic attraction between multiple magnets. Said invention and the present invention are both applicable to books but are otherwise different

The invention under Chinese patent number CN 201044992 Y describes a loose-leaf textbook system involving a book that uses spiral wire binding. The present invention differs in its binding as it uses magnetic binding instead of spiral. The present invention may or may nut involve loose-leaf pages.

The invention under European patent number WO 2013/188677 A1 is a book binding system that involves the utilization of elongate rods, elongate link members, and rod couplers about the edges of pages. The binding system in said invention is contrary to the magnetic binding system in the present invention. Said invention includes an apparatus for flexible book binding that involves an elongate rod and a rod coupler for the pages, whereas the present invention does not involve such an apparatus.

The invention under Chinese patent number CN 202782245 U is a detachable textbook wherein the pages in the textbook are hole-punched, whereas the present invention does not require hole-punched paper for the binding of the pages in the book.

The invention under Canadian patent number CA 1106720 A1 includes a frame for use with a binder comprising an actuator plate and locking plates, whereas the present invention does not involve any of such plates in its binding system as magnetic attraction is fully involved instead.

The closest resemblance to the present invention is the three-ring binder, under U.S. Pat. No. 5,607,246 A, wherein groups of a plurality of pages may be inserted into or removed from a single pair of front and back covers. The Ring Binder requires all pages and most other insertions to be three-bole punched wherein each page or insertion has three aligned holes along the binding edge. The present invention is more advantageous in that the grouping of pages is more convenient than having hundreds of separate pages mixed together. It would be very difficult to keep organized different portions of individual pages from several different books. Three-hole-punched pages are more likely to rip because their holes simply are not durable. The management of two to a few dozen groups of pages, in contrast, is far more convenient and efficient than managing hundreds of individual pages. The spines of three ring binders have a set size and therefore do not compress nor extend. The rings near the spine disallow any possibility of an extendable spine. There is less variability, therefore, in the three ring binder in comparison to the present inventions, though their most basic application of freely inserting and removing pages inside the covers may nonetheless be considered similar.

The composition of traditional hard cover books represents a large part of the construction of the present invention, however there is yet to be found any type of book binding that is based or dependent on the utilization of magnets. The use of magnets as book binding is unique to the present invention and distinguishes the present invention from all prior art.

### BACKGROUND OF THE INVENTION

Traditional textbooks are primarily used by students throughout their middle school, high school, and college years. Rudimentary problems associated with textbooks are, but not limited to, overheating size, overbearing weight, destruction of the insides of backpacks, and lack of complete utilization, by entirety, of the book.

### SUMMARY OF THE INVENTION

The present invention is a system in which books are manufactured and distributed. Students will be able to carry a single, less sizable, and lighter book that will include all of the desired pages from the desired books while requiring only one front and back cover. A textbook, for example, may be divided into ten similarly-sized groups of pages and each of these groups is bound to a respective strip of magnetic material. Magnetic book covers with expandable spines may contain a plurality of these groups that come from any book so long as the book has detachable groups of pages that bind to magnetic strips of material. This evolution to traditional textbooks is not a feature limited to textbooks. Notebooks, folders, and test preparation books, for instance, may take advantage of this modular textbook design and may be used in conjunction with the book covers illustrated in the present invention.

Several groups of pages that come from several different books may be encased between a single pair of book covers for ease of organization, a decrease in space taken up, a decrease in weight, and a decrease in strain on the person's back if the person carries their books in their backpacks. These are only few of the many benefits in this book system design.

Further aspects and advantages will be illustrated in the following descriptions and appended claims.

### BRIEF DESCRIPTION OF THE DRAWINGS

FIG. 1 shows an above perspective view of four sections that come from different books of apparently different sizes. These sections are composed of a plurality of pages and are contained between two bard book covers.

FIG. 2 shows an above perspective view of the standard design of the book covers, which have magnetic strips near the spine. The book covers are shown to be opened and there are no sections between them in this diagram.

FIG. 3 shows an above perspective view of the standard design of the book covers and spine. The covers appear closed and there are no sections between the book covers in this diagram

FIG. 4 shows an above perspective view of the standard design of the book covers and spine. The covers appear closed and there are several sections between the book covers in this diagram

FIG. 5 shows an above perspective view of a standard representation of a single section of a book. The section is composed of a plurality of pages that are bound to a strip of magnetic material.

FIG. 6 shows an above perspective view of all the pages of a book divided into ten individual sections, which are each composed of a plurality of pages and a strip of magnetic material. The left edge of each section, which is where the strip of magnetic material is bound, is shown fanned out to represent the individual sections comprising all the pages in a book.

FIGS. 7a, 7b, 7c, 7d, 7e, & 7f show four sections taken from four different books, stacked on top of one another, and put between two book covers.

### DETAILED DESCRIPTION

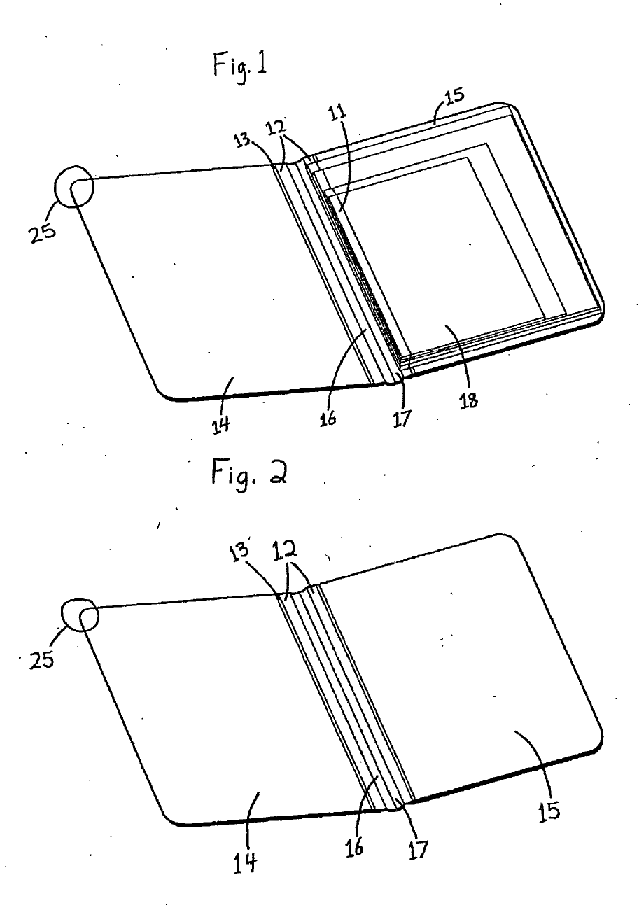

FIG. 1 shows four different-sized sections 18, each of which is composed of a plurality of pages bound to respective strips 11 of magnetic material. These four sections are shown resting atop the inside of the back cover 15, which has curved corners 25, as does the front cover 14. The magnetic strips 12 that are a part of the book cover magnetically attract the magnetic strips 11 of the sections. These two magnetic strips 12 on the covers 14 & 15 are located at the inside edges of the front and back covers. They are near the spine 16 & 17, which is composed of expandable 16 and magnetic 17 materials to allow for more magnetic attraction to the sections as well as the ability to expand and compress in order to contain various different quantities of paper. The spine 16 & 17 may be made up of two separate entities as shown in FIG. 1, wherein one entity is expandable 16 and the other is magnetic 17, or the spine may be a single entity that is either expandable and not magnetic or both expandable and magnetic.

FIG. 2 shows the front and back book covers 14 & 15 and the spine 16 & 17. Connecting the book covers to the spine are the magnetic strips 12 and the thin hinge-like strips 13, which allow the covers to fold back and forth in order to open and close the book. The corners 25 of the cover are curved as a safety measure because the corners of traditional hard cover textbooks may rip the insides of backpacks.

FIG. 3 is similar to FIG. 2 in that they share common aspects, however FIG. 3 shows the front cover 14 above the back cover 15 to illustrate a closed book. The magnetic strip 21. when looking at it from the outside of the book (that is, the same side as the top of the front cover 20), may be of the same material as the material on the inside portion of the strip 12, of the same material as the outside of the front cover 20, or of its own material. The outside of the hinge-like strips 23 will likely be of the same material as the covers 14 & 15. The outside of the spine 22 will be adjustable in size as according to the space required by the sections 18 that are kept between the book covers 14 & 15 at a single instance.

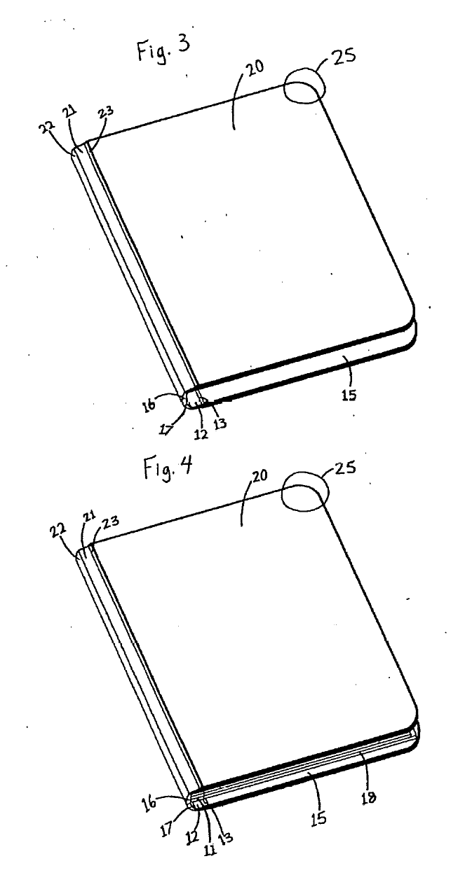

FIG. 4 is similar to FIG. 3 in that they show a closed book cover, however FIG. 4 includes several sections 18 kept in between the book covers to show a filled book in a closed position. The magnetic strips 12 of the covers 14 &15 attract the magnetic strips 11 of the sections 18.

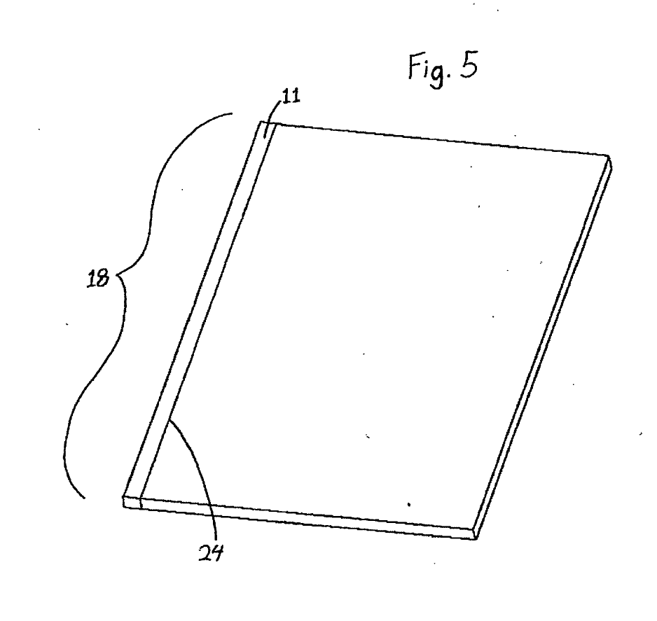

FIG. 5 is a simple representation of a section 18, which includes a plurality of pages and a magnetic strip 11. The pages and magnetic strip 11 adhere to each other by the aid of glue, threading, molding, or any other means of adherence 24.

FIG. 6 is a diagram of ten sections 18 stacked up as a complete book, but without the book covers and spine included. All pages 19 are lined up and the sections attract each other through their magnetic strips 11. Only the three sections at the bottom of FIG. 6, however, are shown attracting one another. The magnetic edges 11 of each of the other seven sections are fanned out to illustrate the ability of each section to separate from one another.

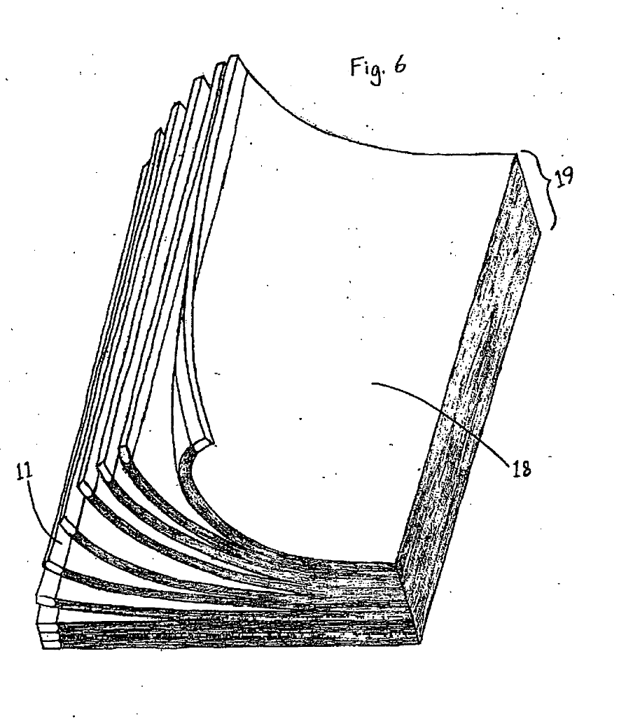

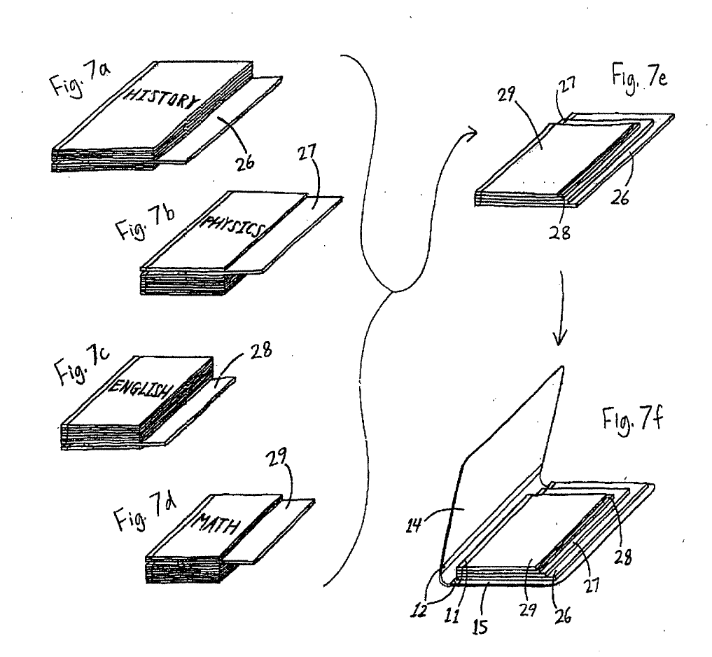

FIGS. 7a, 7b, 7c, & 7d show all of the pages of four textbooks of different subjects and all of their pages divided into individual sections 18. A section 26, 27, 28, & 29 from each book is removed and stacked upon one another in FIG. 7e to show their ability to be put together into a collection of several sections that come from different books. The selected sections are placed between the front 14 and back 15 book covers in FIG. 7f.

Having described this invention in detail and through reference to the pictured embodiments, it is assumed that alterations and modifications are possible without abandoning the scope of the invention.

What is claimed is:

1. A modular book system comprising:
two to ten thousand pages per book;
one to ten thousand groups of pages into which the pages of the book are divided;
magnetic material at the binding edge of each group of pages to which the pages of the group adhere by means of stitching, wire, glue, case binding or any variation thereof, oversewing, sewing through the fold, double-fan adhesive binding, perfect binding, or any other means of bookbinding;
a front and back cover that partially or wholly consists of magnetic material;
a spine that is expandable and may or may not consist of magnetic material;
the aforementioned magnetic material comprising permanent magnets, Neodymium Iron Boron, Samarium Cobalt, ferromagnetic material, Alnico, Ceramic, or Ferrite;

2. The groups of pages in claim 1 wherein the groups may consist of one to ten thousand pages.

3. The book covers in claim 1 wherein said covers have rounded corners.

4. The book covers in claim 1 wherein said covers are relatively inflexible.

5. The spine in claim 1 is connected to the front and back covers described in claim 1 such that they are not intended to separate.

6. The book covers and spine in claim 1 wherein said covers and spine may attach or detach from the binding edge of the pages because the connection between the covers and pages is by means of magnetic attraction.

7. The spine in claim I wherein the material is of an expandable and compressible nature between the front and back covers, such expandable material comprising leather, aluminum, copper, mesh, rayon, knit chevron, cotton, satin, lace, silk, fabric, spandex, latex, two-way stretch fabrics, synthetic fabric, elastane fibers, neoprene, elastomers, wire, steel, or twine.
